(19) United States
(12) Patent Application Publication
(10) Pub. No.: US 2010/0209159 A1
(43) Pub. Date: Aug. 19, 2010

(54) DUPLEX PRINTING APPARATUS

(75) Inventors: Hsi-Yu Chen, Taipei (TW); Chien-Kuo Kuan, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/414,488

(22) Filed: Mar. 30, 2009

(30) Foreign Application Priority Data
Feb. 13, 2009 (TW) 098104589

(51) Int. Cl. G03G 15/00

(52) U.S. Cl. 399/364

(57) ABSTRACT

A duplex printing apparatus includes a paper input tray, a first paper ejecting tray, a second paper ejecting tray, multiple additional roller assemblies, a first paper feeding channel, a second paper feeding channel, a laser printing module, an inkjet printing module, a first paper pick-up roller, a second paper pick-up roller assembly, and a controlling circuit. The first paper ejecting tray and the second paper pick-up roller assembly are arranged between the laser printing module and the inkjet printing module. Since a buffering zone is created to prevent interference between the laser printing operation and the inkjet printing operation, the possibility of causing bent or wrinkled papers from differential moving speeds is largely reduced.

### FIELD OF THE INVENTION

The present invention relates to a duplex printing apparatus, and more particularly to a duplex printing apparatus for performing a duplex printing operation.

### BACKGROUND OF THE INVENTION

With rapid development of electronic industries, a diversity of printing apparatuses such as copiers, printers, scanners or multifunction peripherals become essential information apparatuses in offices. Among these printing apparatuses, the printers are the most popular. In the early stage, a printer can perform a single-side printing operation. For performing duplex printing operations by such a printer, a first page of a document file shown on a computer screen is firstly printed on a first side of a blank paper. After the first page of a document file has been printed, the paper containing the printed image of the first page should be manually turned over and then placed on the paper input tray of the printer. Next, a second page of the document file is printed on a second side of the paper. However, the process of manually turning over the paper is troublesome. This drawback becomes more serious if the document contains a great number of pages. Recently, a duplex printing apparatus has been developed for automatically performing a duplex printing operation.

A conventional duplex printing apparatus has two laser printing modules within the inner portion thereof. For performing a duplex printing operation on a paper, one of the laser printing modules supplies toner onto the first side of the paper and the other of the laser printing modules supplies toner onto the second side of the paper. Although this duplex printing apparatus has a fast printing speed and high throughput, there are still some drawbacks. For example, the uses of two laser printing modules are very costly.

For reducing the fabricating cost, another duplex printing apparatus having a single laser printing module has been developed. FIG. 1 is a schematic view illustrating a conventional duplex printing apparatus having a single laser printing module. As shown in FIG. 1, the duplex printing apparatus 1 principally comprises a paper input tray 10, a paper ejecting tray 11, a paper pick-up roller 12, a paper feeding channel 13, a laser printing module 14, an inkjet printing module 15 and a paper ejecting roller assembly 16. The blank papers P to be printed are placed on the paper input tray 10. The printed papers are supported on the paper ejecting tray 11. The paper feeding channel 13 is arranged between the paper input tray 10 and the paper ejecting tray 11 such that the papers P are allowed to be transported through the paper feeding channel 13. The paper pick-up roller 12 may transport a paper P from the paper input tray 10 into the paper feeding channel 13. The laser printing module 14 is arranged at a first flank of the paper feeding channel 13 for printing an image on the first side of the paper P. The inkjet printing module 15 is arranged at a second flank of the paper feeding channel 13 for printing an image on the second side of the paper P. The paper ejecting roller assembly 16 is used for ejecting the paper P to the paper ejecting tray 11.

Please refer to FIG. 1 again. The laser printing module 14 includes a laser scanning unit 141, an optical photoconductive drum 142, a charging roller 143, a developer roller 144, a transferring roller 145 and a fusing roller assembly 146. The inkjet printing module 15 includes an inkjet print head for ejecting ink on the paper P.

Hereinafter, a procedure of performing a duplex printing operation by the conventional duplex printing apparatus 1 will be illustrated with reference to FIG. 1.

First of all, the image of the first page of a document file is read and transmitted to the laser scanning unit 141. Then, the charging roller 143 uniformly charges the outer surface of the optical photoconductive drum 142. After the charging procedure, the laser scanning unit 141 linearly scans the image of the first page in a form of laser beams, thereby forming an electrostatic latent image of the first page on the optical photoconductive drum 142. Next, a toner cartridge (not shown) supplies toner to the developer roller 144. The developer roller 144 contacts with the optical photoconductive drum 142 for supplying the electrostatic latent image on the optical photoconductive drum 142 with toner. As a consequence, the electrostatic latent image formed on the optical photoconductive drum 142 is rendered visible as a toner image. After the above image processing procedures are performed by the laser printing module 14, the paper pick-up roller 12 transports a paper P from the paper input tray 10 into the paper feeding channel 13. When the paper P is transported to the region between the optical photoconductive drum 142 and the transferring roller 145, the paper P is attracted onto the surface of the optical photoconductive drum 142 and contacted with the toner. Since the transferring roller 145 at the backside of the paper P and the toner are oppositely charged, the toner on the optical photoconductive drum 142 will be adsorbed onto the first side of the paper P. After the toner image is transferred to first side of the paper P, the paper P with the toner image is transported to the fusing roller assembly 146. The paper P is heated and pressed by the fusing roller assembly 146, so that the toner is molten and penetrated into the space between fibers of the paper P. Meanwhile, the printing operation of the first page of the document file is completed.

Next, the paper P containing the printed first page is transported to the inkjet printing module 15. During the paper is transported across the inkjet printing module 15, the image of a second page of the document is printed on the second side of the paper P by ejecting ink on the second side of the paper P. Next, the paper P is transported to the paper ejecting tray 11 by the paper ejecting roller assembly 16. Meanwhile, the duplex printing operation is completed.

Since the duplex printing apparatus 1 of FIG. 1 uses the inkjet printing module to replace one of the two laser printing modules of the conventional duplex printing apparatus, the fabricating cost is reduced. The duplex printing apparatus 1 of FIG. 1, however, still has some drawbacks. For example, since the printing speed of the laser printing module is faster than that of the inkjet printing module, the moving speed at the front end of the paper is different from the moving speed at the tail end of the paper during the front end of the paper enters the inkjet print region but departs from the laser print region. Due to differential moving speeds of the paper at the front and tail ends, the paper is readily bent and wrinkled. If the printing speed difference between the laser printing module and the inkjet printing module is very large, the tail end of the paper is possibly twisted together and thus the paper is not flat. Under this circumstance, the printing quality of the duplex printing apparatus 1 is deteriorated. Moreover, since the printing speed of the laser printing module is faster than that of the inkjet printing module, the laser printing operation of the second paper could not be done during the first paper is transported across the inkjet print region. In other words, until the inkjet printing operation of the first paper is about to be done or has been done, the laser printing operation of the second paper is performed. Under this circumstance, the time period of successively printing papers is extended.

### SUMMARY OF THE INVENTION

It is an object of the present invention to provide a duplex printing apparatus having a laser printing module and an inkjet printing module.

Another object of the present invention provides a duplex printing apparatus for performing a duplex printing operation with reduced operating time.

In accordance with an aspect of the present invention, there is provided a duplex printing apparatus for printing images on a first side and a second side of a paper. The duplex printing apparatus includes a paper input tray, a first paper ejecting tray, a second paper ejecting tray, a first paper feeding channel, a first paper pick-up roller, a second paper feeding channel, a second paper pick-up roller assembly, multiple additional roller assemblies, a laser printing module and an inkjet printing module. The paper is placed on the paper input tray. The first paper ejecting tray is used for supporting the paper. The second paper ejecting tray is used for supporting the paper. The first paper feeding channel is arranged between the paper input tray and the first paper ejecting tray. The first paper pick-up roller is arranged between the paper input tray and the first paper feeding channel for transporting the paper from the paper input tray into the first paper feeding channel. The second paper feeding channel is arranged between the first paper ejecting tray and the second paper ejecting tray. The second paper pick-up roller assembly is arranged between the first paper ejecting tray and the second paper feeding channel for transporting the paper from the first paper ejecting tray to the second paper feeding channel. The additional roller assemblies are arranged in the first paper feeding channel and the second paper feeding channel for transporting the paper. The laser printing module is arranged in the first paper feeding channel for printing the images on a first side of the paper when the paper is transported across a laser print region. The inkjet printing module is arranged in the second paper feeding channel for printing the image on a second side of the paper when the paper is transported across an inject print region.

In an embodiment, the second paper pick-up roller assembly includes a second paper pick-up roller, a paper separation roller, a paper pick-up arm and a friction-enhancing paper separation slice. The paper pick-up arm is connected to the second paper pick-up roller and the paper separation roller for changing a relative position between the second paper pick-up roller and the paper separation roller. The friction-enhancing paper separation slice is sustained against the paper for offering a friction force to the paper, so that only one paper is fed into the second paper feeding channel by the paper separation roller.

In an embodiment, the duplex printing apparatus further includes a controlling circuit for controlling rotating speeds of the additional roller assemblies, the first paper pick-up roller and the second paper pick-up roller assembly.

In an embodiment, the laser printing module includes a laser scanning unit, an optical photoconductive drum, a charging roller, a developer roller, a transferring roller and a fusing roller assembly.

In an embodiment, the fusing roller assembly includes a heating roller and a pressing roller. The heating roller is used for providing heat to melt toner supplied from the laser printing module. The pressing roller is used for pressing the paper such the toner is adsorbed onto the first side of the paper.

In an embodiment, the additional roller assemblies include a first paper feeding roller assembly, a second paper feeding roller assembly, a first paper ejecting roller assembly and a second paper ejecting roller assembly. The first paper feeding roller assembly is arranged in the first paper feeding channel. The second paper feeding roller assembly is arranged in the second paper feeding channel. The first paper ejecting roller assembly is arranged between the first paper feeding channel and the first paper ejecting tray. The second paper ejecting roller assembly is arranged between the second paper feeding channel and the second paper ejecting tray.

In an embodiment, the first paper feeding roller assembly is operated at a first rotating speed. The second feeding roller assembly is operated at a second rotating speed slower than the first rotating speed.

In an embodiment, the inkjet printing module includes an inkjet print head and a transmission mechanism. The inkjet print head is used for ejecting ink on the second side of the paper. The transmission mechanism is connected with the inkjet print head for moving the inkjet print head.

In an embodiment, the inkjet print head is arranged above the second paper feeding channel, so that the ink ejected by the inkjet print head naturally drops on the paper.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a conventional duplex printing apparatus having a single laser printing module; and

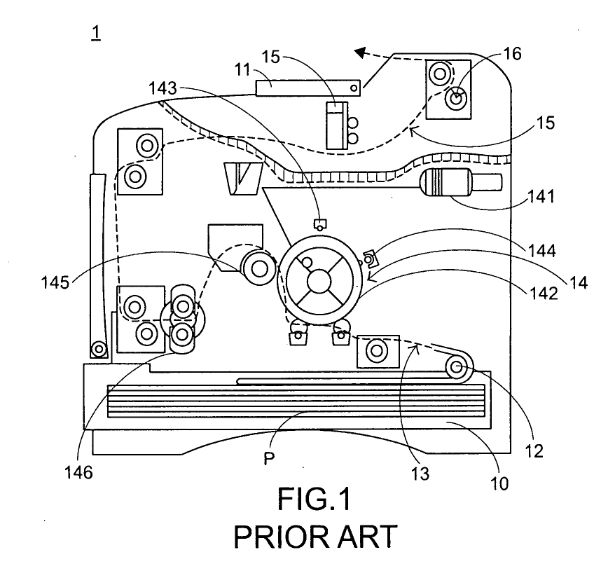

FIG. 2 is a schematic view illustrating a duplex printing apparatus according to a preferred embodiment of the present invention.

### DETAILED DESCRIPTION OF THE PREFERRED EMBODIMENT

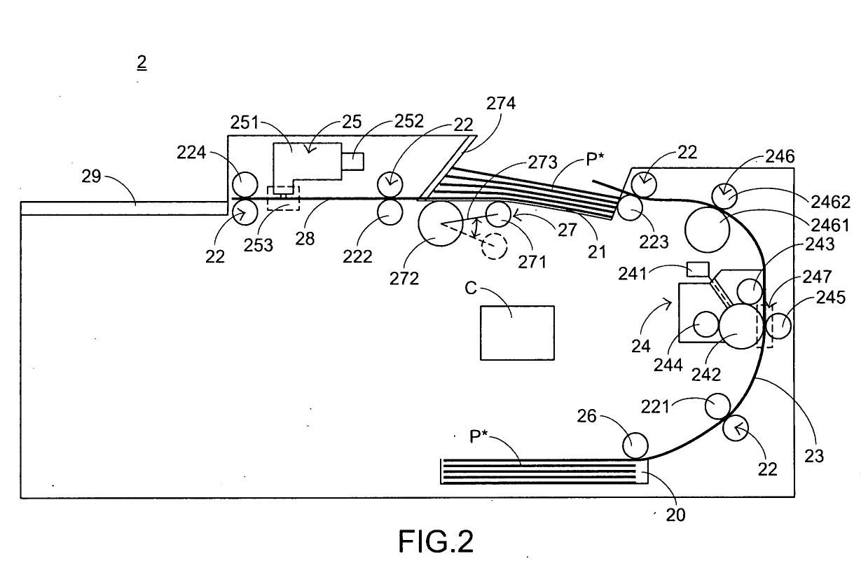

FIG. 2 is a schematic view illustrating a duplex printing apparatus according to a preferred embodiment of the present invention. As shown in FIG. 2, the duplex printing apparatus 2 principally comprises a paper input tray 20, a first paper ejecting tray 21, a second paper ejecting tray 29, multiple additional roller assemblies 22, a first paper feeding channel 23, a second paper feeding channel 28, a laser printing module 24, an inkjet printing module 25, a first paper pick-up roller 26, a second paper pick-up roller assembly 27 and a controlling circuit C.

In the duplex printing apparatus 2, the blank papers P* to be printed are placed on the paper input tray 20. The first paper ejecting tray 21 is used for supporting blank papers or printed papers. The second paper ejecting tray 29 is used for supporting printed papers. The first paper feeding channel 23 is arranged between the paper input tray 20 and the first paper ejecting tray 21 such that the papers P* are allowed to be transported through the first paper feeding channel 23. The second paper feeding channel 28 is arranged between the first paper ejecting tray 21 and the second paper ejecting tray 29. The first paper pick-up roller 26 is arranged between the paper input tray 20 and the first paper feeding channel 23 for transporting the paper P* from the paper input tray 20 into the first paper feeding channel 23. The second paper pick-up roller assembly 27 is arranged between the first paper ejecting tray 21 and the second paper feeding channel 28 for transporting the paper P* from the first paper ejecting tray 21 to the second paper feeding channel 28. The second paper pick-up roller assembly 27 includes a second paper pick-up roller 271, a paper separation roller 272, a paper pick-up arm 273 and a friction-enhancing paper separation slice 274. The operations of the components included in the second paper pick-up roller assembly 27 will be illustrated later. The laser printing module 24 is arranged in the first paper feeding channel 23 for printing an image on the first side of the paper P*. The inkjet printing module 25 is arranged in the second paper feeding channel 28 for printing an image on the second side of the paper P*. The additional roller assemblies 22 are arranged in the first paper feeding channel 23 and the second paper feeding channel 28 for transporting the paper P*. In an embodiment, these additional roller assemblies 22 include a first paper feeding roller assembly 221, a second paper feeding roller assembly 222, a first paper ejecting roller assembly 223 and a second paper ejecting roller assembly 224. The first paper feeding roller assembly 221 is arranged in the first paper feeding channel 23. The second paper feeding roller assembly 222 is arranged in the second paper feeding channel 28. The first paper ejecting roller assembly 223 is arranged between the first paper feeding channel 23 and the first paper ejecting tray 21. The second paper ejecting roller assembly 224 is arranged between the second paper feeding channel 28 and the second paper ejecting tray 29.

Please refer to FIG. 2 again. The laser printing module 24 includes a laser scanning unit 241, an optical photoconductive drum 242, a charging roller 243, a developer roller 244, a transferring roller 245 and a fusing roller assembly 246. The transferring roller 245 of the laser printing module 24 is arranged at a first side of the first paper feeding channel 23. The other components of the laser printing module 24 are arranged at a second side of the first paper feeding channel 23. When the paper P* is transported across a laser print region 247 between the optical photoconductive drum 242 and the transferring roller 245, a laser printing operation is performed on the first side of the paper P*. The fusing roller assembly 246 includes a heating roller 2461 and a pressing roller 2462. The heating roller 2461 can provide heat to melt the toner supplied from a toner cartridge (not shown) of the laser printing module 24. The pressing roller 2462 can press the paper P*. That is, the toner is molten and penetrated into the space between fibers of the paper when the paper P* is heated and pressed by the heating roller 2461 and the pressing roller 2462, so that the toner is adsorbed onto the first side of the paper P*.

The inkjet printing module 25 includes an inkjet print head 251 and a transmission mechanism 252. The inkjet print head 251 is used for ejecting ink on the second side of the paper Pt. The transmission mechanism 252 is connected with the inkjet print head 251 for moving the inkjet print head 251, so that the inkjet print head 251 ejects ink on the second side of the paper P*. The inkjet print head 251 is arranged beside the second paper feeding channel 28 and faces the second side of the paper P* in order to print the second side of the paper P*. In particular, the inkjet print head 251 is arranged above the second paper feeding channel 28, so that the ink ejected by the inkjet print head 251 naturally drops on the paper P*. Since the ink naturally drops on the paper P* by gravity, the inkjet printing quality is enhanced. The operating principles of the laser printing module 24 and the inkjet printing module 25 are known in the art, and are not redundantly described herein.

Under control of the controlling circuit C, the rotating speeds of the roller assemblies 22, the first paper pick-up roller 26 and the second paper pick-up roller assembly 27 are adjustable. In an embodiment, the first paper feeding roller assembly 221 is operated at a faster rotating speed than the second paper feeding roller assembly 222 under control of the controlling circuit C. The rotating speed of the first paper feeding roller assembly 221 indicates the laser printing speed. The rotating speed of the second paper feeding roller assembly 222 indicated the inkjet printing speed.

Hereinafter, a procedure of performing a duplex printing operation by the duplex printing apparatus 2 will be illustrated with reference to FIG. 2.

For printing the images of a first page and a second page of a document file on both sides of a paper P*, the paper P* on the paper input tray 20 is fed into the first paper feeding channel 23 by first paper pick-up roller 26. Next, the paper P* is transported to the laser print region 247 by the first paper feeding roller assembly 221, which is arranged in the first paper feeding channel 23. When the paper P* is transported across the laser print region 247, the image of the first page of the document file is printed on the first side of the paper P* by the laser printing module 24. Next, the paper P* is transported by the fusing roller assembly 246 and heated and pressed by the fusing roller assembly 246, so that the toner is adsorbed onto the first side of the paper P*. Next, the paper P* is transported to the first paper ejecting tray 21 by the first paper ejecting roller assembly 223. Meanwhile, the first side of the paper P* has been printed.

For printing the image of the second page of the document file on the second side of the paper P*, the second paper pick-up roller 271 of the second paper pick-up roller assembly 27 is switched to a first position such that the second paper pick-up roller 271 is in direct contact with the paper P*. Upon rotation of the second paper pick-up roller 271, the paper P* is transported across the friction-enhancing paper separation slice 274 and then fed into the second paper feeding channel 28 by the paper separation roller 272. Next, the paper P* is transported to an inkjet print region 253 by the second paper feeding roller assembly 222, which is arranged in the second paper feeding channel 28. When the paper P* is transported across the inkjet print region 253, the inkjet print head 251 ejects ink on the second side of the paper P* and then the paper P* is transported to the first paper ejecting tray 29 by the second paper ejecting roller assembly 224. Meanwhile, the second side of the paper P* has been printed.

In the above embodiment, the duplex printing apparatus of the present invention is illustrated by printing both sides of a single paper. Nevertheless, the duplex printing apparatus of the present invention can print the images of many pages of a huge document file on both sides of multiple papers. The papers on the paper input tray are successively transported across the first paper feeding channel 23, so that the images of the odd numbered pages of the document file are printed on the first sides of these papers by the laser printing module 24. After the printing operations, these papers are successively transported to the first paper ejecting tray 21.

Ideally, the papers on the first paper ejecting tray 21 are successively fed into the second paper feeding channel 28 by the second paper pick-up roller 271 and the paper separation roller 272. As a consequence, the images of the even numbered pages of the document file are printed on the second sides of these papers by the inkjet printing module 25. After the printing operations, these papers are successively transported to the second paper ejecting tray 29. Meanwhile, the duplex printing operation is completed.

In some instance, during the bottommost paper (the first paper) on the first paper ejecting tray 21 is transported, the second paper is transported to the first paper ejecting tray 21 and stacked on the first paper. For preventing simultaneously transporting the first paper and the second paper, the first paper and the second paper are stooped by the friction-enhancing paper separation slice 274 of the second paper pick-up roller assembly 27. At the same time, the friction-enhancing paper separation slice 274 is sustained against bottommost paper (the first paper) that is placed on the first paper ejecting tray 21, so that only the bottommost paper is fed into the second paper feeding channel 28 by the paper separation roller 272 for each time. Due to cooperation of the friction-enhancing paper separation slice 274 and the paper separation roller 272, the remaindering papers are successively transported into the second paper feeding channel 28 one by one. The papers are successively printed by the inkjet printing module 25 and transported to the second paper ejecting tray 29, thereby finishing the duplex printing operations.

Moreover, the duplex printing apparatus 2 can be used to perform a single-side printing operation. The user can select the laser printing module 24 or the inkjet printing module 25 to perform the single-side printing operation. For selecting the laser printing module 24 to perform the single-side printing operation, the user may move the paper pick-up arm 273 of the second paper pick-up roller assembly 27 such that the relative position between the second paper pick-up roller 271 and the paper separation roller 272 is changed. In an embodiment, the second paper pick-up roller 271 is moved from the first position to a second position in the direction indicated as the dotted line, so that the papers on the first paper ejecting tray 21 are no longer contacted with the second paper pick-up roller 271. Under this circumstance, single-side laser printing operations are successively performed on the papers by the laser printing module 24, and the printed papers are ejected to the first paper ejecting tray 21. Since the second paper pick-up roller 271 is moved to the second position, it not necessary to feed the paper that has been laser printed into the inkjet print region 253 and even the second paper feeding channel 28. Moreover, since the first paper ejecting tray 21 is exposed outside the duplex printing apparatus 2, the laser-printed papers on the first paper ejecting tray 21 can be removed as required.

On the other hand, for selecting the inkjet printing module 25 to perform the single-side printing operation, the second paper pick-up roller assembly 27 needs to be switched to the first position. In addition, the blank papers are placed on the first paper ejecting tray 21 and thus the first paper ejecting tray 21 functions as a paper input tray. Under this circumstance, single-side inkjet printing operations are successively performed on the papers by the inkjet printing module 25, and the printed papers are ejected to the second paper ejecting tray 29.

In some embodiments, the paper pick-up arm 273 is exempted from the duplex printing apparatus 2. The second paper pick-up roller 271 is fixed at the first position. Under control of the controlling circuit, the second paper pick-up roller 271 is rotated to perform the single-side inkjet printing operation, or the rotation of the second paper pick-up roller 271 is ceased in order to perform the single-side laser printing operation.

From the above description, since the first paper ejecting tray and the second paper pick-up roller assembly are arranged between the laser printing module and the inkjet printing module, a buffering zone is created to prevent interference between the laser printing operation and the inkjet printing operation. As such, the possibility of causing bent or wrinkled papers is largely reduced. Moreover, since the laser printing module and the inkjet printing module are independent of each other, the higher-speed laser printing module and the lower-speed inkjet printing module can be individually done. As a consequence, the duplex printing apparatus of the present invention is more time-saving and efficient.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A duplex printing apparatus for printing images on a first side and a second side of a paper, said duplex printing apparatus comprising:
a paper input tray for placing said paper thereon;
a first paper ejecting tray for supporting said paper;
a second paper ejecting tray for supporting said paper;
a first paper feeding channel arranged between said paper input tray and said first paper ejecting tray;
a first paper pick-up roller arranged between said paper input tray and said first paper feeding channel for transporting said paper from said paper input tray into said first paper feeding channel;
a second paper feeding channel arranged between said first paper ejecting tray and said second paper ejecting tray;
a second paper pick-up roller assembly arranged between said first paper ejecting tray and said second paper feeding channel for transporting said paper from said first paper ejecting tray to said second paper feeding channel;
multiple additional roller assemblies arranged in said first paper feeding channel and said second paper feeding channel for transporting said paper;
a laser printing module arranged in said first paper feeding channel for printing said images on a first side of said paper when said paper is transported across a laser print region; and
an inkjet printing module arranged in said second paper feeding channel for printing said image on a second side of said paper when said paper is transported across an inject print region.

2. The duplex printing apparatus according to claim 1 wherein said second paper pick-up roller assembly includes:
a second paper pick-up roller;
a paper separation roller;
a paper pick-up arm connected to said second paper pick-up roller and said paper separation roller for changing a relative position between said second paper pick-up roller and said paper separation roller; and
a friction-enhancing paper separation slice sustained against said paper for offering a friction force to said paper, so that only one paper is fed into said second paper feeding channel by said paper separation roller for each time.

3. The duplex printing apparatus according to claim 1 further comprising a controlling circuit for controlling rotating speeds of said additional roller assemblies, said first paper pick-up roller and said second paper pick-up roller assembly.

4. The duplex printing apparatus according to claim 1 wherein said laser printing module includes a laser scanning unit, an optical photoconductive drum, a charging roller, a developer roller, a transferring roller and a fusing roller assembly.

5. The duplex printing apparatus according to claim 4 wherein said fusing roller assembly comprises:
a heating roller for providing heat to melt toner supplied from said laser printing module; and
a pressing roller for pressing said paper such said toner is adsorbed onto said first side of said paper.

6. The duplex printing apparatus according to claim 1 wherein said additional roller assemblies include:
a first paper feeding roller assembly arranged in said first paper feeding channel;
a second paper feeding roller assembly arranged in said second paper feeding channel;
a first paper ejecting roller assembly arranged between said first paper feeding channel and said first paper ejecting tray; and
a second paper ejecting roller assembly arranged between said second paper feeding channel and said second paper ejecting tray.

7. The duplex printing apparatus according to claim 6 wherein said first paper feeding roller assembly is operated at a first rotating speed, and said second feeding roller assembly is operated at a second rotating speed slower than said first rotating speed.

8. The duplex printing apparatus according to claim 1 wherein said inkjet printing module includes:
an inkjet print head for ejecting ink on said second side of said paper; and
a transmission mechanism connected with said inkjet print head for moving said inkjet print head.

9. The duplex printing apparatus according to claim 8 wherein said inkjet print head is arranged above the second paper feeding channel, so that the ink ejected by said inkjet print head naturally drops on said paper.
